(19) United States
(12) Patent Application Publication
(10) Pub. No.: US 2014/0018094 A1
(43) Pub. Date: Jan. 16, 2014

(54) SPATIAL DETERMINATION AND AIMING OF A MOBILE DEVICE

(71) Applicants: Gilad Oren, Tel Aviv (IL); Limor Lahiani, Tel Aviv (IL); Fadi Haik, Shafaram (IL)

(72) Inventors: Gilad Oren, Tel Aviv (IL); Limor Lahiani, Tel Aviv (IL); Fadi Haik, Shafaram (IL)

(73) Assignee: Microsoft Corporation, Redmond, WA (US)

(21) Appl. No.: 13/548,218

(22) Filed: Jul. 13, 2012

(51) Int. Cl. H04W 64/00

(52) U.S. Cl. 455/456.1

(57) ABSTRACT

Architecture that creates a multi-dimensional spatial model of a mobile device based on data obtained from sensors, such as associated with the mobile device, for example. The spatial model defines the location of the mobile device in space, as well as the device orientation (e.g., heading, and tilt). The spatial model is used to determine a target location (or point) in space at which the mobile device is aiming. The spatial model can be generated based on sensing subsystems that include, but are not limited to, geolocation subsystem (e.g., GPS-global positioning system), a directional (or heading) sensor such as a compass, and gyroscope information to calculate the device tilt relative to the target location.

### BACKGROUND

Mobile devices such as cell phones continue to evolve in both hardware and software capabilities at least with respect to the sensors. For example, mobile devices can include imaging subsystems for taking pictures and videos, speech recognition subsystems for voice control, motion subsystems that include an accelerometer for measuring acceleration and speed, and a geolocation subsystem (e.g., global positioning system) for determining the geolocation of the device. However, automated coordinated efforts to utilize these capabilities in the desired ways remain a challenge.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture creates a multi-dimensional spatial model of a mobile device based on data obtained from sensors associated with the mobile device. The spatial model defines the location of the mobile device in space, as well as the device orientation (e.g., heading, and tilt). The spatial model is used to determine a target location (or point) in space at which the mobile device is aiming. The spatial model can be generated based on sensing subsystems that include, but are not limited to, geolocation subsystem (e.g., GPS-global positioning system), a directional (or heading) sensor such as a compass, and gyroscope information to calculate the device tilt relative to the target location.

The device tilt and heading indicates how the device is oriented as pointing (or aiming) relative to the target position (or target point). The target location can be calculated as on a straight line that extends from the device location along the path of aim. Thus, the straight line path is computed as extending through any structures such as buildings, trees, or mountains, for example. The path of aim can also be defined as a ballistic curve (movement of an object along a three-dimensional path) from the device location to the target location, where the aim is over and/or around the structures (e.g., buildings, hills, etc.) such that gravitational effects, propulsive force, and ballistic conditions (and environment factors such as weather) can be considered. Other path types can also be implemented that further consider the object type, and propellant of an object directed to the target position, such as for a guided missile, and so on.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative embodiment of a system that further includes a point component.

FIG. 3 illustrates exemplary orientation and directional axes where the mobile device is a cell phone.

FIG. 4 illustrates an exemplary targeting diagram using a spatial model created by the mobile device.

FIG. 5 illustrates an exemplary diagram where the mobile device employs a direct path to a structure.

FIG. 6 illustrates a method in accordance with the disclosed architecture.

FIG. 7 illustrates an alternative method in accordance with the disclosed architecture.

FIG. 8 illustrates illustrated a block diagram of a computing system that executes spatial modeling for spatial aiming in accordance with the disclosed architecture.

### DETAILED DESCRIPTION

Mobile device applications can utilize the spatial location and orientation information (e.g., position and tilt) of the associated mobile device to refer to other objects in the real world. One example may involve a gun shooting game program on a mobile device where the device is “aimed” (according to a preconfigured tilt) to “shoot” another real world device or object. Another example may be a camera or augmented reality (AR) application that displays additional details which are relevant to the location (target) at which the device is aiming.

Applications can utilize geolocation information (e.g., GPS (global positioning system) coordinates) to infer the composition of the immediate environment of the device, and/or use the camera to infer objects the device is “looking at” (e.g., buildings, parks, etc.) in the immediate environment of the device and/or distant from the device.

The disclosed architecture provides the capability of pointing (aiming) the device in a specific direction and enabling the device to determine a target in that direction. In accordance with a more complex capability, the architecture can further consider an angle of aim (relative to the horizontal plane) in the specific direction. By combining the data from a mobile device sensors, the exact point in space where the device is aiming, can be determined. GPS location, compass direction, and gyroscope information can be utilized to calculate the spatial characteristics (e.g., location and orientation) of the mobile device and the target position. The target position can be calculated as a straight line going from the base position in a certain angle, or as a ballistic curve or any other path.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

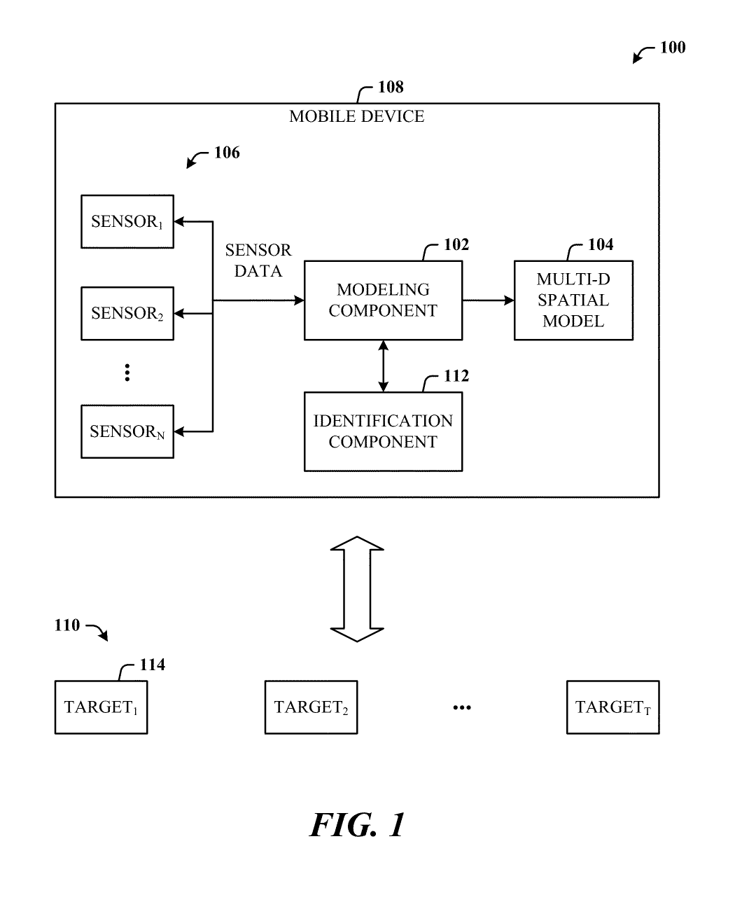

FIG. 1 illustrates a system 100 in accordance with the disclosed architecture. The system 100 can includes a modeling component 102 that automatically builds a current multi-dimensional (MULTI-D) spatial model 104 from sensor data of sensors 106 of a mobile device 108. The model 104 defines spatial properties of the mobile device 108 relative to an environment of the mobile device 108. The spatial properties include location and orientation of the mobile device 108 relative to targets 110.

An identification component 112 identifies a physical object as a target (e.g., target 114) based on the current spatial model 104 and determines object information. For example, the physical object can be a building, a user (as associated and identified with a participating user device), stationary or moving. The multi-dimensional model is a three-dimensional (3D) model relative to a point of reference in the environment and the targets. The point of reference can be geographical coordinates of the mobile device.

The sensor data can include any one or more of accelerometer data, gyroscopic data, geolocation coordinate data, or directional data, as obtained locally from or by the mobile device 108. The accelerometer data can include data from one or more accelerometers. For example, a tri-axial accelerometer arrangement can be utilized to determine motion in the x, y, and z directions, as configured. The gyroscopic data can be obtained from an onboard gyroscope of the mobile device 108. The geolocation (geographic location) coordinate data can be obtained from a geographical coordinate derivation system such as GPS (Global Positioning System), triangulation, or other coordinate systems and techniques.

The physical location of the spatial properties of the device is geographical physical coordinates (latitude/longitude) that does not consider height (or altitude) of the device; however, in a more complex implementation, the altitude of the device may be factored into the spatial model for more precise model computing. The directional data can be obtained from an onboard compass of the mobile device 108.

It is to be understood that although more optimal performance may be achieved by utilizing onboard sensor data subsystems, it is contemplated that some of the sensor data may be obtained from remote sources such as servers. Additionally, although the sensor data employed herein focuses primarily on three to four sensor types, it is also possible to utilize data from other mobile device subsystems, such as a camera to perform image capture and recognition to determine direction, motion, velocity, location, etc.

The identification component 112 facilitates presentation of a notification (or information) at the target which indicates the mobile device applied an action to the target. That is to say, if first and second users are playing a game where the first user searches and finds the second user and performs an action (e.g., “fires”) with respect to the second user, the second user can be notified that the first user has “fired” on the second user. The identification component 112 facilitates presentation of the location of the mobile device (of the first user) and the location of the target (e.g., a building, a second user, etc.) on a virtual map of the mobile device. Thus, the first user can view the first user's location on the map relative to the second user (or object such as a building) on the map.

The environment of the mobile device is the physical and/or surrounding geographical location of the device. For example, the environment of the device as presented on a map may be the geographical area defined within a ten mile radius of the base position. In another example, the environment may be the location of the device as within a block, structure, state, region of a country, country, or world, etc. The environment of the mobile device can also be defined to include environmental conditions such as temperature, humidity, pressure, altitude, and so on. Accordingly, the environment of the mobile device includes a map in which the mobile device is located.

As shown, the mobile device 108 can automatically identify some or all of the targets 110 as the user moves the device 108 to point in different directions. Moreover, it is possible to identify multiple targets along the same direct or indirect path. A user can then choose one or more of the targets with which to interact. Thus, in a gaming scenario, the user can engage multiple targets individually, consecutively, or simultaneously, directly and/or according to ballistic curves.

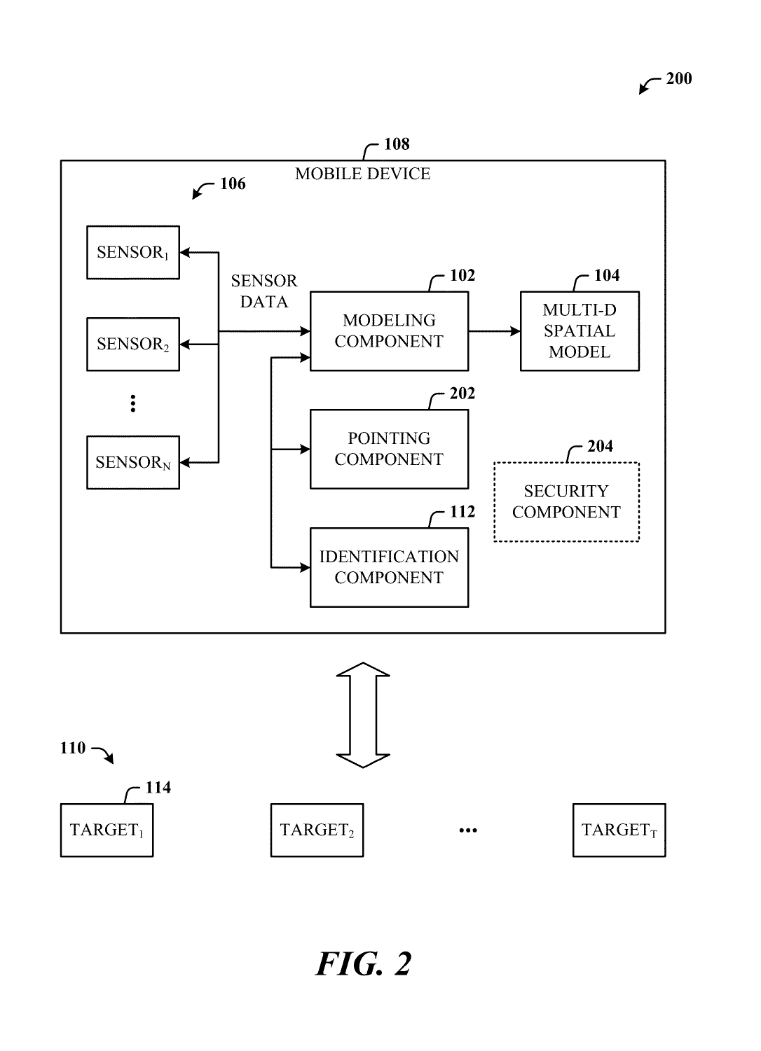

FIG. 2 illustrates an alternative embodiment of a system 200 that further includes a point component 202. The system 200 includes the system 100 and the pointing component, which computes the orientation the mobile device as pointing at the object, based on the spatial model. The pointing component 202 computes a direct path or an indirect path from the mobile device to the object. Thus, the spatial properties now include the location of the mobile device 108, orientation of the device, and pointing direction of the device. It should be understood that the pointing component 202 can also be part of the modeling component 102.

The system 200 can optionally employ a security component 204 for authorized and secure handling of user information. The security component 204 enables the device user to opt-in and opt-out of exposing information to other users or a network, for example, as well as personal information that may have been obtained as part of a game subscription and utilized thereafter. The user can be provided with notice of the collection of personal information, for example, and the opportunity to provide or deny consent to do so.

The security component 204 can also enable the user to access and update profile information. For example, the user can view the personal and/or identification and geolocation data that has been collected, and provide corrections.

The security component 204 ensures the proper collection, storage, and access to the user information while allowing for the dynamic selection and presentation of the content, features, and/or services that assist the user/subscriber to obtain the benefits of a richer user experience and to access to more relevant information.

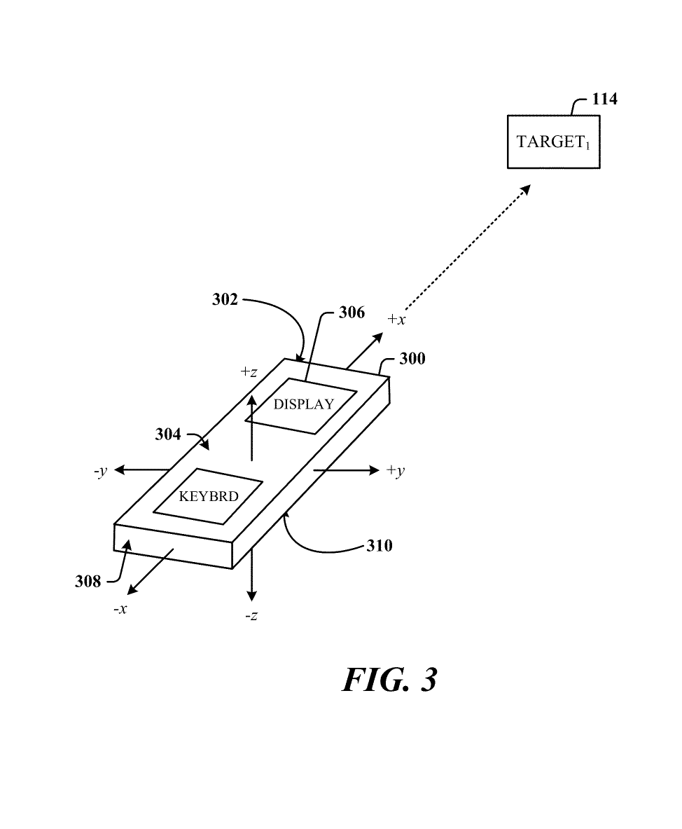

FIG. 3 illustrates exemplary orientation and directional axes where the mobile device is a cell phone 300. The orientation of the mobile device 108 as defined herein includes parameters that characterize how the mobile device 108 is positioned in space. This includes the pitch, angle, and roll, as commonly understood, as well as pointing direction of the device 108 relative to the target 114.

The pointing direction can be computed in any way configured by the user. For example, when considering the cell phone 300 as the mobile device 108, the cell phone 300 is a 3D rectangular-shaped object where the length (longest dimension or side) has an associated x axis defined along the length, the width (next longest dimension or side) has a y axis defined along the width, and the thickness (shortest dimension or side) has a z axis defined there along.

In one basic example, the pointing direction of the cell phone 300 can be configured solely along the x axis (of the length), or they axis (of the width), or the z axis (of the thickness). In more complex configurations, the pointing direction can be configured at a resultant angle of two or more of the axes (e.g., x and y, y and z, z and x, or x, y and z). Moreover, the pointing direction (or heading) can also be configured as towards either end of the axes (e.g., the −x direction).

For example, typically, the pointing direction is along the +x axis from the top 302 (surface) of the phone 300 with the user facing the front 304 (surface) of the phone 300 and a display 306 is viewed normally from the front 304 facing upwards—the pointing direction is from the top 302 of the phone 300 towards the target 114.

However, it can be the case that the pointing direction is along the −x axis from the bottom 308 (surface) of the phone 300 as the user is facing the front 304 of the phone, but the display 306 is viewed upside down or inverted. Thus, the pointing direction is from the bottom 308 of the phone 300 towards the target 114. Additionally, given that the phone 300 has a front 304 (surface) and a back 310 (surface), alternatively, it can be the case that the front 304 (or +z axis) is the pointing direction. Other orientations can be employed to create the direction of pointing. For example, angular rotation can be made around any one or more of the three axes.

In one implementation, the mobile device 108 features a geolocation sensor (e.g., GPS), a compass, and a gyroscope and/or accelerometer, which can be used to build the spatial model of the device 108. The spatial model is used to create the path in physical space from the device 108 to the target 114. As previously noted, the path may be a straight line, a ballistic path, a curve, etc.

The geolocation coordinates define the base point of the path. The compass is used to determine the direction or azimuth at which the device 108 is pointing. The accelerometer and/or gyroscope can be used to determine the device orientation: angle, the roll, and the pitch at which the device 108 is laying.

The geolocation sensor and the accelerometer can also be used to determine the speed and acceleration at which the device 108 is moving, which contributes to the calculation of the path and/or the force at which an object (target 114) is shot. The azimuth and angle of the device 108 creates a straight line in space originating at the base point. This line can also be converted to a ballistic curve by adding other physical parameters such as for gravity, wind, or to any other path by applying any custom calculation using the base point, the speed, the acceleration, the azimuth, and the angle.

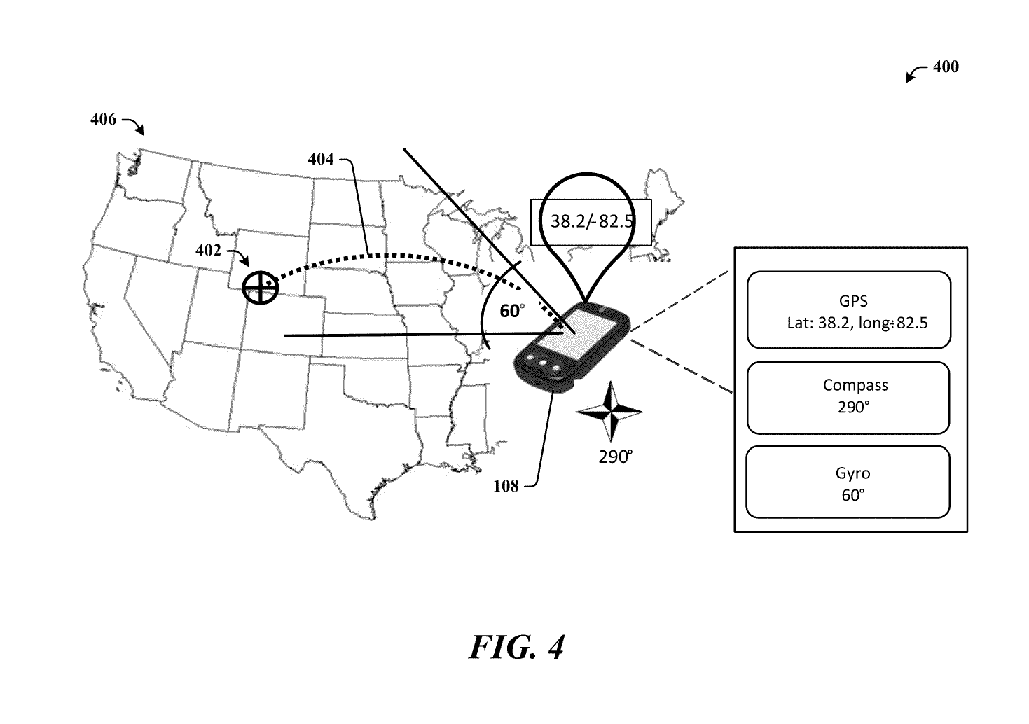

FIG. 4 illustrates an exemplary targeting diagram 400 using a spatial model created by the mobile device 108. The mobile device 108 “shoots” (a user interaction) at a physical target 402 along an indirect (or ballistic) path 404. Here, the spatial model is defined using a GPS signal where the device geolocation (also referred to as its location or base position) is 38.2 degrees latitude and −82.5 degrees longitude as determined according to an onboard geolocation transceiver subsystem. The device 108 orientation for the spatial model is facing at an azimuth (compass heading or pointing direction) of 290° as determined by an onboard compass. The device 108 is tilted 60° above the horizon (e.g., according to the x axis of FIG. 3), as determined according to an onboard gyroscope.

Given that the device 108 is pointing (the front of the device 108) in the general direction of the target 402, but not directly at the target 402, any projectile or other game object can be launched (or shot) along the ballistic path 404 to engage the target 402.

As previously indicated, when employed as part of a mobile device game where users choose to share their location and other information suitable for playing the game, the target 402 can be another player or simply an inanimate object or location (e.g., building, landmark, etc.). In the game scenario, the target 402 and the device 108 both can receive updated information for presentation to the respective users. For example, the user at the target 402 can receive notification that s/he was targeted and shot, and by whom, while the user of the device 108 can receive notification that the target 402 was engaged (shot successfully) and the identity of the target user. Other information can be presented to either or both parties (device user or/and target user) as desired, such as the sensor data, date, time, game scores, etc.

The map 406 can be displayed on the device 108 so that the device user can see its location relative to the target 402. The map 406 can be obtained from a mapping service as tiles that are continually being replaced and updated as the device user moves, as the target 402 moves, as the device user moves relative to the target 402, or both the target 402 and the device user relative to each other. It is to be understood that the map tiles for a given region or area can be automatically retrieved and downloaded to the device 108 based identification of the device location as the device moves.

Of course, where the target user is a game player and employs the same capabilities of the disclosed architecture, the target user can ascertain the device user as a target and shoot back at the device user as part of the game. It is also to be understood that more than two game players can participate to each create spatial models for orientation and pointing to ascertain other players or inanimate targets.

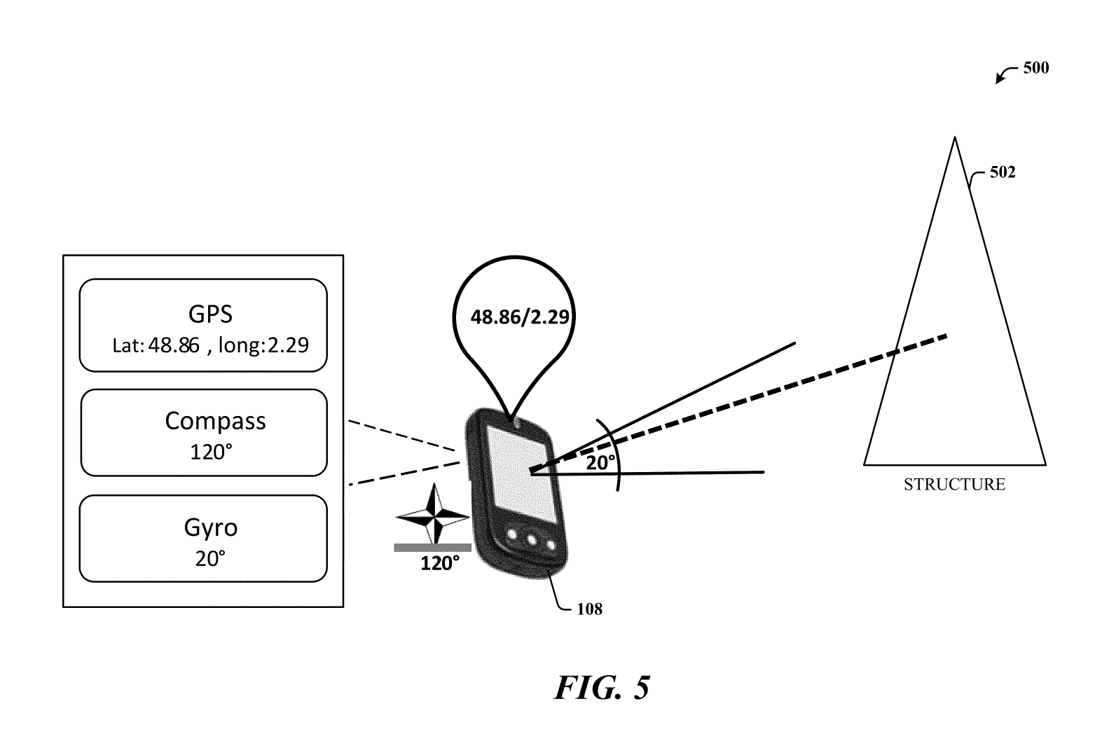

FIG. 5 illustrates an exemplary diagram 500 where the mobile device 108 employs a direct path to a structure 502. The device user stands on the ground and points the device 108 at the structure 502 (e.g., building, monument, landmark, etc.). In response, the device user can be shown details about the structure 502 such as structure name, address, cross streets, geolocation information, height, etc. Here, the device 108 geolocation (base position) is 48.86 degrees latitude and 2.29 degrees longitude. The device 108 is facing at azimuth 120 degrees, and tilted 20 degrees above the horizon.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

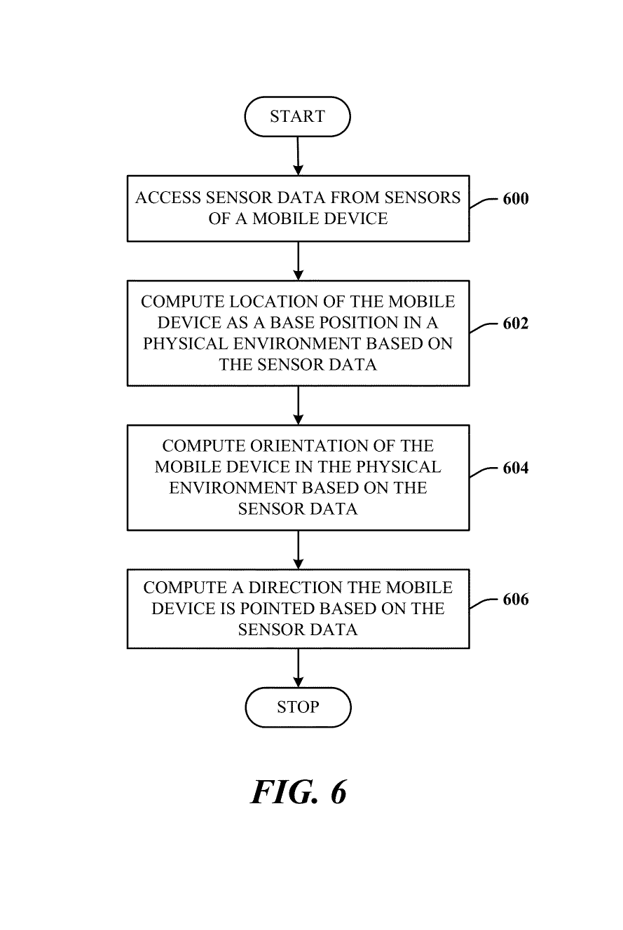

FIG. 6 illustrates a method in accordance with the disclosed architecture. At 600, sensor data from sensors of a mobile device is accessed. The sensors can include, but are not limited to, a geolocation subsystem (e.g., GPS), compass, accelerometer, and gyroscope. At 602, location of the mobile device is computed as a base position in a physical environment based on the sensor data. The base position can be the geolocation of the device. The physical environment can be a geographical area or region. At 604, orientation of the mobile device in the physical environment is computed based on the sensor data. The orientation includes the general lay of the device along the three axes while at the base position. At 606, a direction the mobile device is pointed is computed based on the sensor data. This can be computed from the onboard compass.

The method can further comprise identifying a physical object (e.g., building, monument, other user device, etc.) in the direction the mobile device is pointed as a target, presenting object information (e.g., name of the object, name of the user associated with the object, etc.) of the object on the mobile device on a map (related to the area or region), and notifying the object (e.g., user) of an interaction by the mobile device. The interaction can be via game participation where a target user is shot at, messaged, and so on.

The method can still comprise computing a path (direct or indirect) from the base position (of the mobile device) to the target based on the orientation of the mobile device relative to the target, and computing speed and acceleration of the mobile device relative to the target for computation of a path between the mobile device and the target.

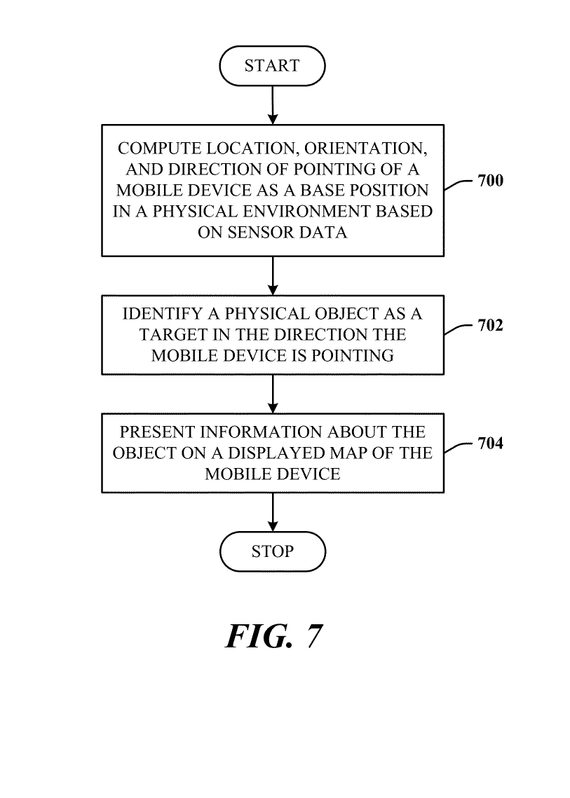

FIG. 7 illustrates an alternative method in accordance with the disclosed architecture. At 700, location, orientation, and direction of pointing of a mobile device are computed as a base position in a physical environment based on sensor data. At 702, a physical object is identified as a target in the direction the mobile device is pointing. At 704, information about the object is presented on a displayed map of the mobile device.

The method can further comprise identifying the object as a user and notifying the user via a user device that an action has been applied via the mobile device. A direct path can be computed from the base position to the target in the direction the mobile device is pointing. An indirect path can be computed from the base position to the target in the direction the mobile device is pointing, the indirect path a ballistic curve to the target that considers physical and environmental parameters. The base position of the mobile device can be computed from at least one of accelerometer data, gyroscopic data, geographical coordinate data, or directional data.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

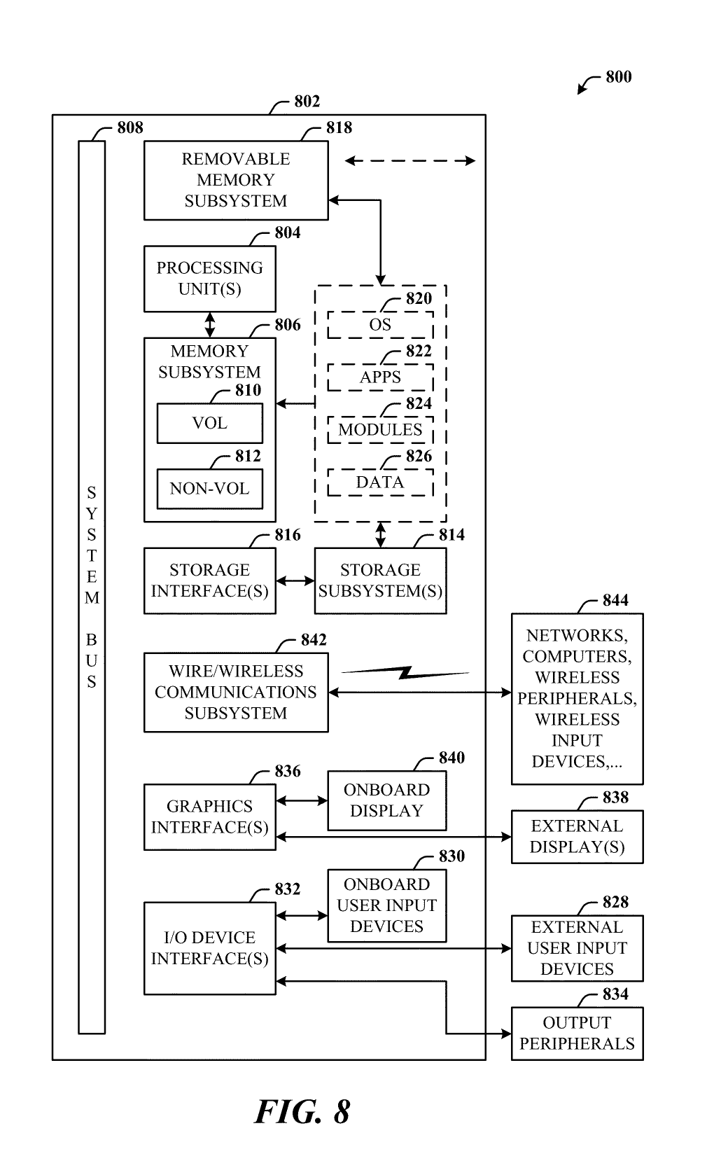

Referring now to FIG. 8, there is illustrated a block diagram of a computing system 800 that executes spatial modeling for spatial aiming in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include entities and components of the system 100 of FIG. 1, entities and components of the system 200 of FIG. 2, and where employed in a cell phone, the entities and components as shown in the cell phone 300 of FIG. 3, entities and components of the diagram 400 of FIG. 4, entities and components of the diagram 500 of FIG. 5, and the methods represented by the flowcharts of FIGS. 6 and 7, for example.

It is to be understood that the disclosed architecture applies equally to mobile devices such as cell phones, portable computers, tablet computers, and the like.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a modeling component that automatically builds a current multi-dimensional spatial model from sensor data of sensors of a mobile device, the model defines spatial properties of the mobile device relative to an environment of the mobile device, the spatial properties include location and orientation of the mobile device relative to targets;
an identification component that identifies a physical object as a target based on the current spatial model and determines object information; and
a microprocessor that executes computer-executable instructions in a memory.

2. The system of claim 1, wherein the multi-dimensional model is a three-dimensional (3D) model relative to a point of reference in the environment and the targets.

3. The system of claim 2, wherein the point of reference is a geographical coordinate of the mobile device.

4. The system of claim 1, further comprising a pointing component that computes the orientation the mobile device as pointing at the object, based on the spatial model.

5. The system of claim 4, wherein the pointing component computes a direct path or an indirect path from the mobile device to the object.

6. The system of claim 1, wherein the sensor data includes at least one of accelerometer data, gyroscopic data, geolocation coordinate data, or directional data.

7. The system of claim 1, wherein the identification component facilitates presentation of a notification at the target which indicates the mobile device applied an action to the target.

8. The system of claim 1, wherein the identification component facilitates presentation of the location of the mobile device and the location of the target on a virtual map of the mobile device.

9. The system of claim 1, wherein the environment of the mobile device includes a map in which the mobile device is located.

10. A method, comprising acts of:
accessing sensor data from sensors of a mobile device;
computing location of the mobile device as a base position in a physical environment based on the sensor data;
computing orientation of the mobile device in the physical environment based on the sensor data;
computing a direction the mobile device is pointed based on the sensor data; and
utilizing a processor that executes instructions stored in a memory.

11. The method of claim 10, further comprising identifying a physical object in the direction the mobile device is pointed as a target.

12. The method of claim 11, further comprising presenting object information of the object on the mobile device on a map.

13. The method of claim 11, further comprising notifying the object of an interaction by the mobile device.

14. The method of claim 10, further comprising computing a path from the base position to the target based on the orientation of the mobile device relative to the target.

15. The method of claim 10, further comprising computing speed and acceleration of the mobile device relative to the target for computation of a path between the mobile device and the target.

16. A method, comprising acts of:
computing location, orientation, and direction of pointing of a mobile device as a base position in a physical environment based on sensor data;
identifying a physical object as a target in the direction the mobile device is pointing;
presenting information about the object on a displayed map of the mobile device; and
utilizing a processor that executes instructions stored in a memory.

17. The method of claim 16, further comprising identifying the object as a user and notifying the user via a user device that an action has been applied via the mobile device.

18. The method of claim 16, further comprising computing a direct path from the base position to the target in the direction the mobile device is pointing.

19. The method of claim 16, further comprising computing an indirect path from the base position to the target in the direction the mobile device is pointing, the indirect path a ballistic curve to the target that considers physical and environmental parameters.

20. The method of claim 16, further comprising deriving the base position of the mobile device from at least one of accelerometer data, gyroscopic data, geographical coordinate data, or directional data.
